(19) United States
(12) Patent Application Publication
(10) Pub. No.: US 2015/0084246 A1
(43) Pub. Date: Mar. 26, 2015

(54) COOLING SYSTEM FOR METALLURGICAL FURNACES AND METHODS OF OPERATION

(71) Applicant: General Electric Company, Schenectady, NY (US)

(72) Inventors: Ching Jen Tang, Watervliet, NY (US); Joo Han Kim, Niskayuna, NY (US)

(73) Assignee: General Electric Company, Schenectady, NY (US)

(21) Appl. No.: 14/037,810

(22) Filed: Sep. 26, 2013

(51) Int. Cl. F27D 9/00

(52) U.S. Cl. CPC F27D 9/00; F27D 2009/0002
USPC 266/46; 266/241; 266/99; 165/53; 165/11.1

(57) ABSTRACT

A metallurgical furnace system having a furnace body at least partially defined by a refractory wall and configured for holding a molten metal therein. The system further including one or more cooling elements, each including a working fluid contained therein and defining a heat absorption section and a heat rejection section. The heat absorption section configured for disposing within the refractory wall to absorb heat from the refractory wall. The heat rejection section configured to reside outside the refractory wall to reject heat absorbed by the heat absorption section. The working fluid generating a vapor flow within the one or more cooling elements in response to absorbed heat. The cooling system further including a coolant flow in contact with an exterior surface of the one or more cooling elements for dissipating heat from the heat rejection section. A cooling system for a metallurgical furnace and method of cooling are also disclosed.

### BACKGROUND

The disclosure relates generally to metallurgical furnaces, and, more specifically, to cooling systems for metallurgical furnaces.

It is well known in the field of metallurgy to use specialized furnaces for the purpose of processing metals. These specialized furnaces may include blast furnaces, open hearth furnaces, oxygen furnaces, electric arc furnaces, electric induction furnaces, reheating furnaces, and any other furnace commonly known in the field. Metallurgical furnace units typically comprise refractory walls, a furnace vessel and auxiliary components for cooling. The refractory walls of a metallurgic furnace are often subjected to extremely high temperatures and corrosive environments that may result in erosion to the walls as a result of thermal cycling. To protect the refractory walls, it is often necessary to introduce a cooling device to reduce the temperature of the sidewalls. Although many types of cooling devices have been used to cool the refractory walls, these cooling devices either provide insufficient cooling or may leak coolant into the furnaces. In particular instances, liquids, such as water, are often used as the primary mechanism for heat transfer in such furnaces. In the event of a leak, the contact of the leaking liquid with hot molten metal contained inside the furnace may result in steam explosion, and present safety hazards. In addition, a coolant leakage, such as water, is often extremely difficult to detect when a conventional liquid cooling system is used.

It would therefore be desirable to provide a cooling system for metallurgical furnaces and methods of operation that address the above shortcomings. In addition, it would be desirable to provide a cooling system for metallurgical furnaces and methods of operation that provides for increased cooling capabilities, effectiveness and leak detection, in an attempt to avoid the need to shut down the furnace and effect costly repairs.

### BRIEF DESCRIPTION

One aspect of the present disclosure resides in a cooling system for a metallurgical furnace. The cooling system including one or more cooling elements each defining a heat absorption section and a heat rejection section, a working fluid contained therein the one or more cooling elements and a coolant flow in contact with an exterior surface of the one or more cooling elements. The heat absorption section configured for disposing within a refractory wall of a metallurgical furnace to absorb heat from the refractory walls. The heat rejection section configured to reside outside the refractory walls of the metallurgical furnace to reject heat absorbed by the heat absorption section. The working fluid, upon heating in the heat absorption section, generates a vapor flow within the one or more cooling elements. The coolant providing for the dissipation of heat from the heat rejection section of the one or more cooling elements.

Another aspect of the present disclosure resides in a metallurgical furnace system. The metallurgical furnace system including a metallurgical furnace having a furnace body at least partially defined by a refractory wall and configured for holding a molten metal therein and a cooling system. The cooling system including one or more cooling elements each defining a heat absorption section and a heat rejection section, a working fluid contained therein the one or more cooling elements and a coolant flow in contact with an exterior surface of the one or more cooling elements. The heat absorption section is configured for disposing within the refractory wall of the metallurgical furnace to absorb heat from the refractory wall. The heat rejection section is configured to reside outside the refractory wall of the metallurgical furnace to reject heat absorbed by the heat absorption section. The working fluid, upon heating in the heat absorption section, generates a vapor flow within the one or more cooling elements. The coolant provides for the dissipation of heat from the heat rejection section of the at least cooling element.

Yet another aspect of the present disclosure resides in a method for cooling a metallurgical furnace. The method including: (a) embedding one or more cooling elements partially within a refractory wall of a metallurgical furnace, each of the one or more cooling elements comprising a heat absorption section disposed in the refractory wall and a heat rejection section residing outside the refractory wall; (b) flowing a coolant over an exterior surface of the heat rejection section of the one or more cooling elements; (c) absorbing heat from the refractory wall in the heat absorption section of the one or more cooling elements to generate via evaporation a vapor flow within the one or more cooling elements; (d) dissipating heat from the vapor flow into the coolant via condensation within the one or more cooling elements and generating a condensed liquid within the one or more cooling elements; (e) returning the condensed liquid to the heat absorption section of the one or more cooling elements; and (f) repeating steps (b) through (e) to provide continuous cooling to the metallurgical furnace.

Various refinements of the features noted above exist in relation to the various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of the present disclosure without limitation to the claimed subject matter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic cross-section of a metallurgical furnace including a cooling system in accordance with one or more embodiments shown or described herein;

FIG. 2 is a schematic cross-section of a portion of the metallurgical furnace of FIG. 1, in accordance with one or more embodiments shown or described herein;

FIG. 3 is a schematic cross-section of a heat exchanger, and more particularly a heat pipe, for use in the cooling system of the metallurgical furnace of FIG. 1, in accordance with one or more embodiments shown or described herein;

FIG. 4 is a schematic cross-section of an embodiment of a leak detection system of a metallurgical furnace cooling system, in accordance with one or more embodiments shown or described herein;

FIG. 5 is a schematic cross-section of an alternate embodiment of a leak detection system of a metallurgical furnace cooling system, in accordance with one or more embodiments shown or described herein;

FIG. 6 is a schematic cross-section of another alternate embodiment of a leak detection system of a metallurgical furnace cooling system, in accordance with one or more embodiments shown or described herein; and

FIG. 7 is a flow chart depicting one implementation of a method of cooling a metallurgical furnace in accordance with one or more embodiments shown or described herein.

### DETAILED DESCRIPTION

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). In addition, the term “combination” is inclusive of blends, mixtures, alloys, reaction products, and the like.

Moreover, in this specification, the suffix “(s)” is usually intended to include both the singular and the plural of the term that it modifies, thereby including one or more of that term (e.g., “the heat pipe” may include one or more heat pipes, unless otherwise specified). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. Similarly, reference to “a particular configuration” means that a particular element (e.g., feature, structure, and/or characteristic) described in connection with the configuration is included in at least one configuration described herein, and may or may not be present in other configurations. In addition, it is to be understood that the described inventive features may be combined in any suitable manner in the various embodiments and configurations.

The disclosed cooling system for a metallurgical furnace not only provides sufficient cooling of refractory walls but may also eliminate the probability of steam explosion due to unwanted contact between the coolant, and more particularly a cooling liquid, such as water, and the molten metal. The elimination or minimization of a steam explosion is a result of the use of a heat exchanges, and more particularly a heat pipe, enabling separation of the coolant from the molten metal. In an embodiment, the heat pipe is a passively-cooled system without any moving parts. In spite of the separation between the heat pipe and a coolant flow, the heat pipe can still effectively transfer the heat from the hot refractory walls of the furnace to the coolant flow. In addition, a novel method of detecting a leak in the cooling device is incorporated such that an operator has time to correct any cooling related issue.

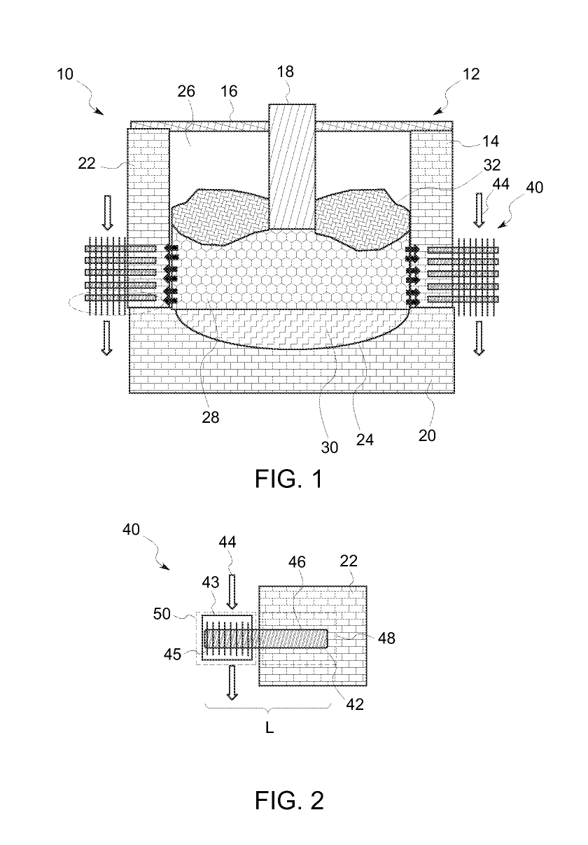

Referring now to FIG. 1, illustrated is a schematic diagram of a metallurgical furnace including a cooling system according to an embodiment disclosed herein and generally referenced 10. In the illustrated embodiment, the metallurgical furnace system 10 is an electric arc furnace 12. It should be understood that although an electric arc furnace is illustrated, any type of metallurgical furnace, such as a blast furnace, an open hearth furnace, an oxygen furnace, an electric induction furnace, a reheating furnace, a flash furnace and any other furnace commonly known in the field in which the cooling system disclosed herein may be integrated is anticipated by this disclosure. The furnace 12 is generally configured as a refractory-lined vessel 14, including a moveable lid 16 that provides access for one or more electrodes 18 (of which only one is illustrated). The furnace 12 includes a shell 20, including refractory walls 22 and lower bowl shaped component 24. The term refractory walls 22 as used herein, is intended as encompassing of the refractory sidewalls. The refractory walls 22 are typically formed of a material that is chemically and physically stable at high temperatures, such as those in excess of 1,000° F. (538° C.). In an embodiment, the refractory walls 22 may be formed of heat resistant materials, such as oxides of aluminum (alumina), silicon (silica), magnesium (magnesia) or calcium (lime) and define therein a vessel shaped structure 26. In an embodiment, the moveable lid 16 may be shaped as a portion of a sphere, a conical-liked portion, or the like. The moveable lid 16 may be configured to support, and provide access therethrough for the one or more electrodes 18. The furnace 12 is typically configured raised off ground level, for ease in access by slag pots, or the like (not shown). A positioning system (not shown) may be provided for positioning of the one or more electrodes 18.

As illustrated in FIG. 1, during operation of the furnace 12, a slag 28 is formed and floats on the surface of a molten metal 30. The slag 28 is a by-product of a pyro-metallurgical process and acts as a destination for oxidized impurities. The slag 28 is normally comprised of a mixture of metal oxides and silicon dioxide. Some slags may contain metal sulfides and metal atoms in the elemental form. The slag 28 acts as a thermal blanket (stopping excessive heat loss) and helping to reduce erosion of the refractory lining shell 20. Both the molten metal 30 and slag 28 are normally very hot and may exceed temperatures in excess of 3000° F. (1649° C.). As illustrated in FIG. 1, the molten metal 30 normally sinks to the lower bowl shaped component 24 of the furnace 12 and the slag 28 is on the top of the molten metal 30. During operation of the furnace 12, the hot molten metal 30 and slag 28 can attack the refractory walls 22, particularly when a cooling system is not incorporated and cooling applied to the refractory walls 22. In addition, a calcine 32 is illustrated as a result of a calcination process that takes place within the furnace 12.

As previously indicated, the metallurgical furnace system 10, further includes a cooling system 40. The cooling system 40 provides for cooling of the refractory walls 22 of the metallurgical furnace 12.

Illustrated is an enlarged portion of the metallurgical furnace system 10 of FIG. 1, as indicated by the dotted line. More particularly, illustrated in FIG. 2, is the cooling system 40 generally comprised of one or more cooling elements, also referred to herein as heat exchangers or heat pipes, 42 (of which only one is illustrated in FIG. 2). Each of the at least one heat pipes 42 having an overall length “L”, wherein a portion of the length “L” is embedded in the refractory wall 22. The cooling system 40 further includes a coolant flow 44 in contact with an exterior surface 46 of the heat pipe. The embedding of at least a portion of the heat pipe 42 into the refractory wall 22 provides for a heat absorption section 48 and a heat rejection section 50. The heat absorption section 48, and more particularly the portion of the heat pipe 42 that is embedded in the refractory wall 22, is not in direct physical contact with the coolant flow 44. The heat rejection section 50 is in direct physical contact with the coolant flow 44 and thus able to dissipate heat in the refractory walls 22 to the coolant flow 44. In an embodiment, the coolant flow 44 may include air, a liquid, such as water, and/or other fluids capable of absorbing heat. Each of the one or more heat pipes 42 thermally connects the heat absorption section 48 and the heat rejection section 50 and provides a physical separation between the coolant flow 44 and the refractory walls 22. This physical separation prevents any contact of the coolant flow 44 with the molten metal 30 or slag 28 (FIG. 1).

In an embodiment, the heat rejection section 50, and more particularly a portion of the heat pipe 42 may have formed thereabout a shell 43 and fin 45 structure to provide for improved flow of the coolant 44 about the heat rejection section 50.

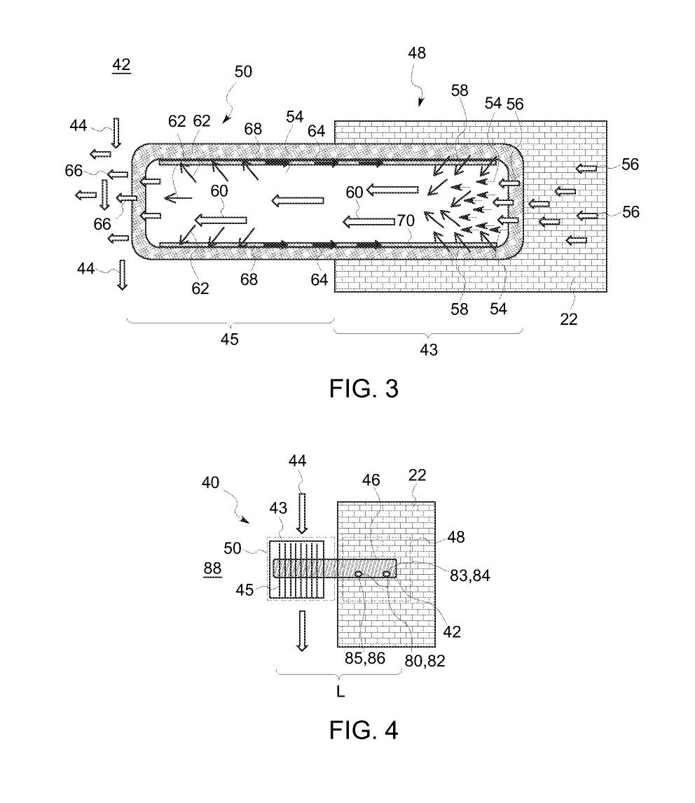

Referring now to FIG. 3, illustrated in an enlarged schematic cross-section is a single heat pipe 42 and the operational principles of the cooling system 40 of the metallurgical furnace system 10. The heat pipe 42 is illustrated as having a portion 43 embedded within the refractory walls 22 and a portion 45 protruding therefrom the refractory walls 22. Each of the one or more heat pipes 42 is configured as a vacuum having a working fluid 54 disposed therein. In an embodiment, each of the one or more heat pipes 42 is comprised of a material, such as metals, ceramics, polymers, etc., that is capable of conducting heat and inert to the working fluid 54, so as to stop air from leaking into the heat pipe 42 or working fluid 54 leaking out of the heat pipe 42. In an embodiment, the heat pipe 42 may be formed of a metal, such as copper (Cu), titanium (Ti), aluminum (Al), or the like. The working fluid 54 disposed therein may comprise water, methanol, sodium ethanol, or the like, depending on system requirements, such as operating temperature. During operation of the metallurgical furnace system 10, the working fluid 54 absorbs heat, as indicated at 56, from the refractory walls 22 in the heat absorption section 48 and causing evaporation, as indicated at 58, and formation of a vapor 60. The resulting vapor 60 travels to the heat rejection section 50, due to the system pressure differential, where the vapor 60 condenses, as indicated at 62, into a liquid 64, while rejecting latent heat 66, to the ambient (coolant 44) through the walls of the heat pipe 42. The resulting condensation liquid 64 travels back to the heat absorption section 48 due to capillary pressure in a wick structure 68 attached to an interior surface 70 of the heat pipe 42. In the heat absorption section 48, the condensed liquid 64 becomes the working fluid 54, again absorbing heat 56 and evaporating 58 as a result of the heat 56 in the refractory walls 22. As a result, the cooling cycle is a continuous process.

During operation of the metallurgical furnace system 10, any leak within the cooling system 40 may cause the working fluid 54 to come in contact with the hot molten metal 30 (FIG. 1) and may result in a steam explosion and present additional safety hazards, accordingly a leak detection may be incorporated. Conventional leak detection systems (not shown) are often composed of two flow sensors: one at an inlet and the other at an outlet of a heat exchanger, such as a heat pipe. When a leak occurs between the inlet and outlet, the detection system can theoretically detect the leakage flow by comparing a measured inlet flow rate to an outlet flow rate. However, when the ratio of the inlet flow rate to the outlet flow rate becomes very large, it is very difficult to detect the outlet flow rate by using this comparison of flow rates due to uncertainty. When a cooling device for the refractory walls starts developing a leak, the ratio of the inlet flow rate to the outlet flow rate is often very large, causing this type of conventional lead detection method to fail.

Referring now to FIGS. 4, 5 and 6, illustrated are embodiments of a leak detection mean incorporated into the cooling system 40 of the metallurgical furnace system 10. FIG. 4 illustrates a first embodiment of a leak detection means 80 comprised of one or more temperature sensors 82 (of which two are illustrated). The leak detection means 80, and more particularly the temperature sensors 82, are configured to enable the detection of a leak of the working fluid 54 (FIG. 3) by comparing a temperature of a first sensor 83 at a first location 84, to one or more additional sensors 85 at one or more additional locations 86. In the illustrated embodiment, a first sensor 83 and a second sensor 85 are illustrated. In the event the heat pipe 42 develops a leak, the heat pipe 42 would stop working. As a result, the difference between the measured temperatures at the first location 84 and the one or more additional locations 86 will change significantly. For example, if the working fluid 54 of the heat pipe 42 is water, and because the heat pipe 42 operates under a vacuum, even a tiny leak can fairly quickly raise the pressure in the heat pipe 42 by drawing ambient gas into the heat pipe 42. As a result, the resistance of the vapor transfer 60 (FIG. 3) from the heat absorption section 48 to the heat rejection section 50 will increase quickly and thus, the temperature difference between the sensors 83 and 85 would significantly increase. It should be understood, that due to the placement of the heat pipe 42 at least partially within the refractory walls 22, and configured so as not intrusive into an interior of the vessel shaped structure 26 (FIG. 1), in the event of a leak, the working fluid 54 does not contact the contents (slag 28, molten metal 30, and/or calcine 32) within the vessel shaped structure 26.

In an embodiment, if a leak develops in the shell 42 within the heat rejection section 50 the leakage flow (water), and more particularly the leaked working fluid 54, will eventually drip down to the floor outside the furnace 12 due to gravity. The leakage flow outside of the furnace can be seen and detected easily. The leakage flow does not enter the furnace 12 to cause the damage to the refractory walls 22.

If a leak develops in the heat absorption section 48, pressure inside the heat pipe 42 will rise quickly to the ambient pressure by drawing ambient air or gas 88 or coolant 44 into the heat pipe 42. Due to an increase in the resistance of the vapor transfer, a detectable temperature difference between the sensors 83 and 85 will increase significantly. If a leak develops in the heat rejection section 50, similarly pressure inside the heat pipe 42 will also increase by drawing ambient air or gas 88 or the coolant 44 into the heat pipe 42. Due to an increase in the resistance of the vapor transfer, a detectable temperature difference between the sensors 83 and 85 will become a strong indicator for a leak.

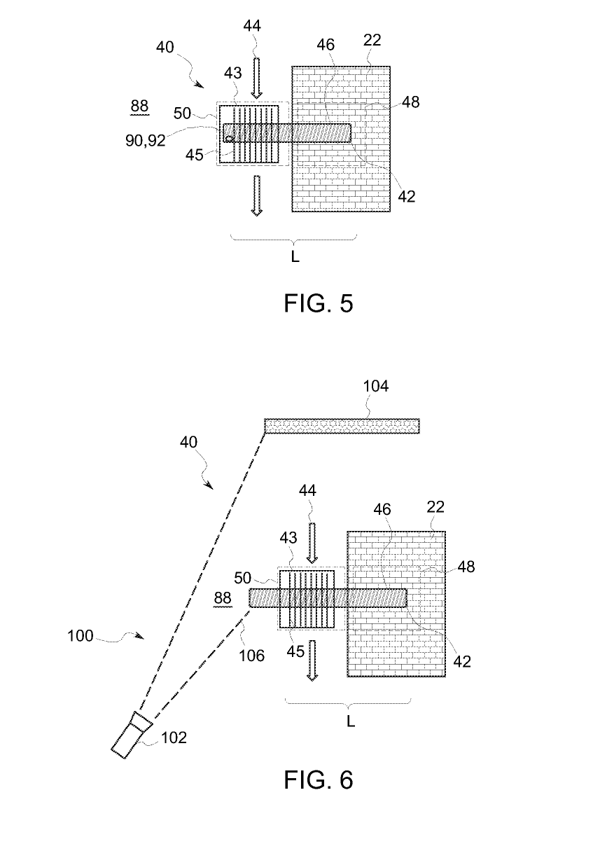

In an alternate embodiment, as best illustrated in FIG. 5, illustrated is a leak detection means incorporated into the cooling system 40 of the metallurgical furnace system 10. Illustrated in FIG. 5 in a schematic cross-sectional view is a second embodiment of a leak detection means 90 comprised of one or more pressure sensors 92 (of which only one is illustrated). In contrast to the previous embodiment, the sensor 92 is a pressure sensor, instead of temperature sensor, for use in detecting a leak. As stated above, when a leak develops, either in the heat absorption section 48 or in the heat rejection section 50, the pressure inside the heat pipe 42 will increase. This pressure increase is detected at sensor 92 and is an indicator of a leak in the cooling system 40.

In yet another alternate embodiment, as best illustrated in FIG. 6, illustrated is another leak detection means incorporated into the cooling system 40 of the metallurgical furnace system 10. Illustrated in FIG. 6 in a schematic cross-sectional view is a third embodiment of a leak detection means 100 comprised of an camera 102 and a processing means 104, such as a computer or the like, positioned relative to the cooling system 40. In the illustrated embodiment, the camera 102 is described as an infra-red camera. In an alternate embodiment, the camera 102 may be a thermal imaging camera, thermographic camera, or the like. In contrast to the previous embodiments, leak detection means 100 does not require the use of sensors, or thermocouples, to determine the presence of a leak in the heat pipe 42. One of the distinctive features of the heat pipe 42 relates to the minimal temperature difference that is needed between the heat absorption section 48 and the heat rejection section 50 to provide for removal of a designed value of heat. When the temperature of the refractory wall 22 proximate the heat absorption section 48 exceeds the designed value, the temperature of the vapor 60 (FIG. 3) inside the heat pipe 42 increases. The temperature of the vapor 60 strongly affects the temperature at a specific location 106 that is visible to the camera 102 and typically proximate the heat rejection end 50, as shown in FIG. 6. As a result, the deviation of the temperature at the specific location 106 increases as the temperature of the refractory wall 22 proximate the heat absorption section 48 increases. This deviation in temperature, along with a pre-established relationship between the specific location 106 and the refractory wall 22, can be used to estimate the temperature of the refractory wall 22 proximate the heat absorption section 48.

The use of the infra-red camera 102 provides for a detailed map of the refractory wall 22 temperatures to be mapped. More particularly, the infra-red camera 102 provides for signals to be submitted to the processing means 104, such as a computer with appropriate software to process the images. The processing means 104, and more particularly the software, will compare the signals to pre-established data to provide temperature data for the refractory wall 22. The software will additionally determine if the temperature is in the appropriate range and how the temperature data is compared to the historical data. The infra-red camera 102 further allows for the temperature of the refractory walls 22 that are in contact with the heat absorption section 48 of the heat pipe 42 to be visible from the heat rejection section 50 of the heat pipe 42. The use of the infra-red camera 102 is significant in that it provides temperature information that otherwise may only be obtainable through the inclusion of numerous thermocouples. In addition, the leak detection means 100 incorporating the use of the infra-red camera 102 thereby eliminates the need to position sensors/thermocouples within the refractory walls 22, such as previously described with regard to FIG. 4, thereby eliminating the need for complex wiring therein.

The proposed cooling system 40 provides sufficient cooling for the refractory walls 22, and has proven to outperform conventional finger coolers, such as those well known in the art. Experimentation has proven that the heat pipe 42 can remove approximately fifty times more heat than when a pure copper cooling element/finger cooler is used. Heat transfer in the cooling system 40 through evaporation and condensation is much faster than conduction coolers that typically place high-conductivity material through furnace walls and cooling water outside walls.

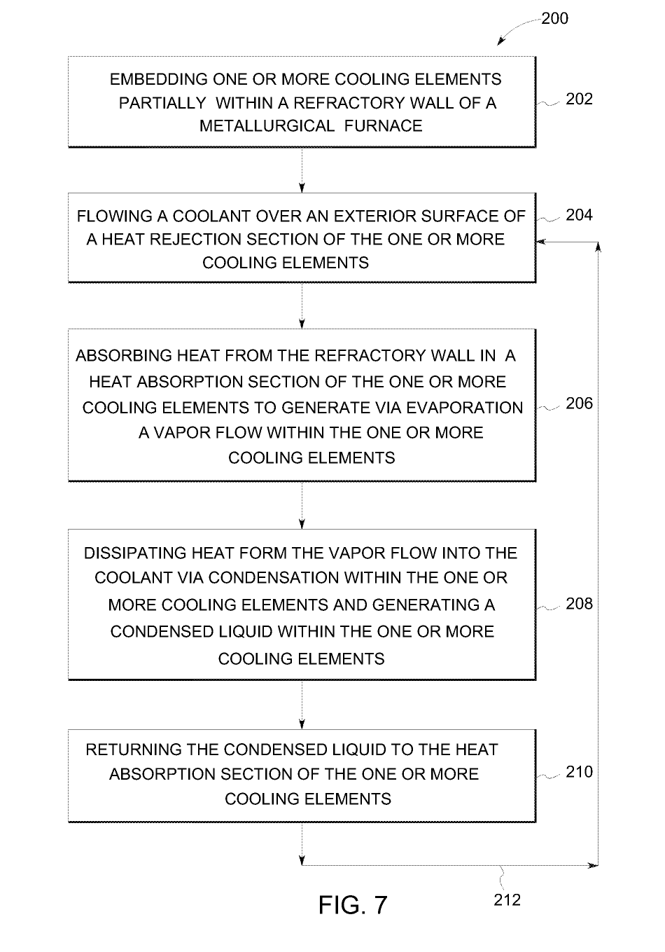

Turning now to FIG. 7, illustrated is a method 200 of cooling a metallurgical furnace according to the disclosed embodiments. The method including the steps of embedding one or more cooling elements partially within a refractory wall of a metallurgical furnace, the cooling element comprising a heat absorption section disposed in the refractory wall and a heat rejection section residing outside the refractory wall, as indicated at step 202. A coolant flow is provided over an exterior surface of the heat rejection section of the one or more cooling elements, in a step 204. The heat from the refractory wall is absorbed in the heat absorption section of the one or more cooling elements to generate via evaporation a vapor flow within the one or more cooling elements, as indicated in a step 206. The heat is dissipated or discharged from the vapor flow into the coolant flow via condensation within the one or more cooling elements, at a step 208. In addition, a condensed liquid is generated within the one or more cooling elements. The condensed liquid is returned to the heat absorption section of the one or more cooling elements, as indicated at step 210. The return of the condensed liquid may be affected through a wicking structure disposed within the cooling element. The previous steps may be repeated to provide continuous cooling to the metallurgical furnace, as indicated at 212. The method may further include the step of monitoring at least one of a temperature or a pressure of the working fluid within the one or more cooling elements to detect a leak in the one or more cooling elements as previously described with reference to FIGS. 4, 5 and 6.

Beneficially, the above described metallurgical furnace system, the included cooling system and cooling method minimizes, if not eliminates, steam explosions in metallurgical furnaces and provides a means for extending the life of metallurgical furnace refractory walls through proper cooling such that the productivity of a pyro-metallurgical process increases. The cooling method uses a heat pipe to separate any coolant liquid from the refractory walls such that the liquid will not directly contact the refractory walls.

Although only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A cooling system for a metallurgical furnace comprising:
one or more cooling elements each defining a heat absorption section and a heat rejection section, the heat absorption section configured for disposing within a refractory wall of the metallurgical furnace to absorb heat from the refractory wall, the heat rejection section configured to reside outside the refractory wall of the metallurgical furnace to reject heat absorbed by the heat absorption section;
a working fluid contained therein the one or more cooling elements, the working fluid upon heating in the heat absorption section, generating a vapor flow within the one or more cooling elements; and
a coolant flow in contact with an exterior surface of the one or more cooling elements for dissipating heat from the heat rejection section of the one or more cooling elements.

2. The cooling system of claim 1, wherein the one or more cooling elements is a heat exchanger.

3. The cooling system of claim 2, wherein the one or more cooling elements is a heat pipe.

4. The cooling system of claim 3, wherein the heat pipe is comprised of at least one of copper, titanium or aluminum.

5. The cooling system of claim 1, further comprising a leak detection means configured to provide indication of a leak in the one or more cooling elements based on at least one of a detectable change in temperature or pressure within the one or more cooling elements.

6. The cooling system of claim 5, wherein the leak detection means comprises one of an infra-red camera, a thermal imaging camera or a thermographic camera configured to provide a temperature map of the refractory wall at a specific location proximate each of the one or more cooling elements.

7. The cooling system of claim 5, wherein the leak detection means comprises at least one sensor configured to provide sensing of a leak in the one or more cooling elements based on at least one of a detectable change in temperature or pressure within the one or more cooling elements.

8. The cooling system of claim 7, wherein the cooling system includes a first temperature sensor at a first location proximate the one or more cooling elements and at least one additional temperature sensor at an additional location proximate the one or more cooling elements, the first temperature sensor and the at least one additional temperature sensor configured to detect a temperature at the first location and at the least one additional location within the one or more cooling elements.

9. The cooling system of claim 7, wherein the cooling system includes a pressure sensor proximate the one or more cooling elements, the pressure sensor configured to detect an increase in pressure within the one or more cooling elements.

10. A metallurgical furnace system comprising;
a metallurgical furnace having a furnace body at least partially defined by a refractory wall and configured for holding a molten metal therein; and
a cooling system comprising:
a coolant flow in contact with an exterior surface of one or more cooling elements for dissipating heat, each of the one or more cooling elements partially disposed within the refractory wall of the metallurgical furnace to absorb heat from the refractory wall.

11. The system of claim 10, wherein the metallurgical furnace is one of a blast furnace, an open hearth furnace, an oxygen furnace, an electric arc furnace, an electric induction furnace or a reheating furnace.

12. The system of claim 10, wherein the cooling system further comprises a leak detection means configured to provide indication of a leak in the one or more cooling elements based on at least one of a detectable change in temperature or pressure within the one or more cooling elements.

13. The system of claim 12, wherein the leak detection means includes a first temperature sensor at a first location proximate the one or more cooling elements and at least one additional temperature sensor at an additional location proximate the one or more cooling elements, the first temperature sensor and the at least one additional temperature sensor configured to detect a temperature at the first location and at the least one additional location within the one or more cooling elements.

14. The system of claim 12, wherein the leak detection means includes a pressure sensor configured to detect a change in pressure within the one or more cooling elements.

15. The cooling system of claim 12, wherein the leak detection means comprises an infra-red camera configured to provide a temperature map of the refractory wall proximate the heat absorption section of each of the one or more cooling elements.

16. The system of claim 10, wherein the one or more cooling elements is a heat pipe.

17. A method for cooling a metallurgical furnace comprising:
(a) embedding one or more cooling elements partially within a refractory wall of a metallurgical furnace, each of the one or more cooling elements comprising a heat absorption section disposed in the refractory wall and a heat rejection section residing outside the refractory wall;
(b) flowing a coolant over an exterior surface of the heat rejection section of the one or more cooling elements;
(c) absorbing heat from the refractory wall in the heat absorption section of the one or more cooling elements to generate via evaporation a vapor flow within the one or more cooling elements;
(d) dissipating heat from the vapor flow into the coolant via condensation within the one or more cooling elements and generating a condensed liquid within the one or more cooling elements;
(e) returning the condensed liquid to the heat absorption section of the one or more cooling elements; and
(f) repeating steps (b) through (e) to provide continuous cooling to the metallurgical furnace.

18. The method of claim 17, further comprising monitoring at least one of a temperature or a pressure of the working fluid within the one or more cooling elements to detect a leak in the one or more cooling elements.

19. The method of claim 17, wherein the step of monitoring at least one of a temperature or a pressure of the working fluid within the one or more cooling elements comprises monitoring at least one of a temperature sensor, a pressure sensor or a temperature map generated by one of an infra-red camera, a thermal imaging camera or a thermographic camera to detect at least one of a temperature or a pressure of the working fluid.

20. The method of claim 17, wherein the one or more cooling elements is a heat exchanger.
